(19) United States
(12) Patent Application Publication
(10) Pub. No.: US 2009/0286437 A1
(43) Pub. Date: Nov. 19, 2009

(54) WIPES WITH RUPTURABLE BEADS

(75) Inventors: Corey T. Cunningham, Larsen, WI (US); Aneshia Ridenhour, Canton, GA (US); Brian M. Langolf, Fond Du Lac, WI (US); Michael A. Schmidt, Alpharetta, GA (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: Kimberly-Clark Worldwide, Inc., Neenah, WI (US)

(21) Appl. No.: 12/120,560

(22) Filed: May 14, 2008

(51) Int. Cl. B32B 3/02; B32B 5/02; B32B 5/26

(52) U.S. Cl. 442/61; 442/59; 442/381

(57) ABSTRACT

The present disclosure generally relates to wipes comprising a fibrous sheet material and beads embedded within the interior of the fibrous sheet material. The beads comprise an active agent and an encapsulation material that surrounds the active agent. The beads are incorporated into the fibrous sheet material as dehydrated beads. Upon hydration of the beads, such as by contact of the wipe with an aqueous solution, such as water or a wetting solution, the dehydrated beads gradually hydrate, becoming soft and rupturable. Also disclosed are methods for producing the wipes.

### BACKGROUND OF THE DISCLOSURE

The present disclosure generally relates to wipes comprising a fibrous sheet material and beads embedded within the interior of the fibrous sheet material. The beads comprise an active agent and an encapsulation material that surrounds the active agent. The beads are incorporated into the fibrous sheet material as dehydrated beads. Upon hydration of the beads, such as by contact of the wipe with water or a wetting solution, the dehydrated beads gradually hydrate, becoming soft and rupturable. When pressure is applied to the hydrated, rupturable beads, such as during normal wipe use, the encapsulation material ruptures, releasing the active agent from the interior of the bead. Also disclosed are methods for producing the wipes.

Wipes have been used in the personal care industry for numerous years for various cleaning and wiping tasks. Wet wipes generally comprise a low level of surfactant and a high level of water base for cleaning bodily fluids or wiping up menses. In recent years, however, consumers have begun demanding more out of personal care products, including wipes. For example, various wipes have come into the market containing ingredients for soothing skin or containing actives for disinfecting surfaces.

Another example of a desired wipe property is the delivery of perceivable consumer aesthetics, moisturization, or other skin health benefits. However, many skin benefit agents that provide the desired aesthetics, moisturization, or other beneficial effects are hydrophobic or otherwise incompatible with the wipe wetting solution. It has thus proven to be difficult, given the generally high amounts of water and small amounts of surfactants present in typical wetting solutions, to incorporate such agents into wipes.

One approach for incorporating incompatible active agents into a wetting solution is to use microencapsulation. Microencapsulation involves the capturing of active agents within an encapsulation material, such as a shell, which can be broken or ruptured to release the active agent at the desired time. The encapsulation material protects the active agent from directly contacting the wetting solution until the encapsulation shell is ruptured during use of the wet wipe. This allows for the active agent to be more readily incorporated into wet wipes.

There are, however, several problems associated with incorporating encapsulated active agents into a wet wipe. For example, the encapsulated active agents may be incorporated into a wet wipe by sprinkling the encapsulated active agents onto the wet wipe basesheet prior to or after wetting of the basesheet with the wetting solution, or by incorporating the encapsulated active agents directly into the wetting solution. However, when these techniques are used, the encapsulated active agents will typically not remain firmly affixed to the basesheet, but rather, may stick to adjacent wet wipes in a wet wipe stack and/or to a tub or container in which the wet wipes are stored.

Other methods of incorporating encapsulated active agents into wet wipes involve adhering the encapsulated active agents to the wet wipe substrate using adhesive. However, the amounts of adhesive required to adhere the encapsulated active agents to the wipe basesheet may prevent the encapsulation material from rupturing to release the active agent when the wipe is used, and may result in a wipe having a rough surface texture.

Furthermore, many conventional techniques for manufacturing wipes exerts pressure on the wipes by grabbing or pulling the wipes in order to move them during manufacture and packaging. This applied pressure may cause the encapsulation material to prematurely rupture and release the encapsulated active agent.

The present disclosure addresses these problems by providing a wipe comprising a fibrous sheet material with beads comprising an active agent and an encapsulation material that surrounds the active agent embedded within the fibrous sheet material. When the wipe is used, the beads are ruptured, releasing the active agent. Advantageously, because the beads are embedded within the fibrous sheet material, they remain within the wipe, rather than sticking to other wipes in a wet wipe stack or containers in which the wipes are stored. Also provided are methods for producing the wipes, which avoid the problem of premature rupture of the beads during manufacturing.

### SUMMARY OF THE DISCLOSURE

The present disclosure generally relates to wipes comprising a fibrous sheet material and beads embedded within the interior of the fibrous sheet material. The beads comprise an active agent and an encapsulation material that surrounds the active agent. The beads are incorporated into the fibrous sheet material as dehydrated beads. Upon hydration of the beads, such as by contact of the wipe with water or a wetting solution, the dehydrated beads gradually hydrate, becoming soft and rupturable. When pressure is applied to the hydrated, rupturable beads, such as during normal wipe use, the encapsulation material ruptures, releasing the active agent from the interior of the bead. Also disclosed are methods for producing the wipes.

In one aspect, the present disclosure is directed to a wet wipe comprising a fibrous sheet material, a wetting solution, and a hydrated, rupturable bead comprising an active agent and an encapsulation material that surrounds the active agent. The hydrated rupturable bead is embedded within the interior of the fibrous sheet material.

In another aspect, the present disclosure is directed to a substantially dry wipe comprising a fibrous sheet material, and a dehydrated bead comprising an active agent and an encapsulation material that surrounds the active agent, the dehydrated bead being capable of hydrating to become a hydrated, rupturable bead upon contact with an aqueous solution. The dehydrated bead is embedded within the interior of the fibrous sheet material.

Other objects and features will be in part apparent and in part pointed out hereinafter.

### BRIEF DESCRIPTION OF THE DRAWINGS

FIG. 1 is a view of one embodiment of a wipe converting process of the present disclosure.

### DETAILED DESCRIPTION OF THE DISCLOSURE

The present disclosure generally relates to personal care products, such as wipes, that comprise a fibrous sheet material and beads embedded within the interior of the fibrous sheet material. The beads comprise an active agent and an encapsulation material that surrounds the active agent. Advantageously, the beads are incorporated into the fibrous sheet material in a dehydrated state. Specifically, when dehydrated, the encapsulation material forms a hard, dry shell that surrounds the active agent. This hard, dry shell formed by the encapsulation material is difficult to break or crush. As such, when the encapsulation material is dehydrated, the beads are less likely to rupture and release the active agent than they would be when hydrated. This is particularly advantageous since wipes are typically subjected to various pressures during manufacturing and conversion processes and/or wipe packaging, which may otherwise result in premature rupture of the beads and release of the active agent. The hard, dehydrated beads are readily converted into soft, rupturable beads upon hydration of the encapsulation material, such as by contact of the wipe with an aqueous solution such as water or other wetting solutions.

Additionally, the beads are embedded within the interior of the fibrous sheet material. This is advantageous since, as noted above, merely applying beads to the outside surface of a wipe or adding them to a wetting solution for use with a wipe may result in the beads sticking to adjacent wet wipes in a wet wipe stack and/or to a tub or container in which wet wipes are stored. This may result in uneven delivery of the active agent to the wipe user. In contrast, wipes of the present disclosure comprise beads embedded within the interior of the fibrous sheet material. By embedding the beads within the interior of the fibrous sheet material, the beads are retained within the individual wipe and will not readily stick to adjacent wet wipes in a stack of wipes and/or to a wet wipe storage tub or container.

Additionally, by embedding the beads within the interior of the fibrous sheet material, the wipes of the present disclosure will have a reduced grittiness feel. Specifically, the beads will be cushioned by the fibrous sheet material, such that the surface of the wipe will not feel rough or gritty on the user's skin. Additionally, when the encapsulation material is ruptured, the ruptured shells will be retained within the fibrous sheet material, rather than contacting or being deposited on the skin of the wipe user. This prevents the ruptured shells from feeling rough on the skin of the wipe user.

Thus, in one aspect, the present disclosure relates to wet wipes comprising a fibrous sheet material, a wetting solution, and hydrated, rupturable beads. The hydrated, rupturable beads comprise an active agent and an encapsulation material that surrounds the active agent. The hydrated, rupturable beads are embedded within the interior of the fibrous sheet material, such that when the beads are ruptured, the active agent is released but the encapsulation material is retained within the fibrous substrate.

In another aspect, the present disclosure also relates to substantially dry wipes comprising a fibrous sheet material and dehydrated beads. The dehydrated beads comprise an active agent and an encapsulation material that surrounds the active agent. The dehydrated beads are embedded within the interior of the fibrous sheet material. Advantageously, the dehydrated beads are capable of hydrating upon contact with an aqueous solution, such as water or a wetting solution, to become hydrated, rupturable beads. When hydrated, the beads are soft and pliable and may be ruptured to release the active agent during wipe use.

As noted above, the wipes of the present disclosure comprise beads embedded within the fibrous sheet material of the wipe. The beads comprise an active agent which is surrounded by an encapsulation material. Depending on the type of wipe, the beads present in the wipe may be either dehydrated beads, such as in the case of a substantially dry wipe, or may be hydrated, rupturable beads, such as in the case of a wet wipe or semi-dry wipe. In all instances, however, the wipes of the present disclosure are initially formed by embedding dehydrated beads within the interior of the fibrous sheet material, as described hereinafter. As noted above, when the beads are dehydrated, the encapsulation material forms a hard, dry shell that surrounds the active agent. This hard, dry shell formed by the encapsulation material is difficult to break or crush and, as such, the beads are less likely to rupture and release the active agent. This prevents the beads from prematurely rupturing during manufacturing and converting processes and/or packaging and shipping of the wipe.

Advantageously, the dehydrated beads are capable of hydrating upon contact with an aqueous, water-based solution to become hydrated, rupturable beads. As used herein, the term “hydrated” means the encapsulation material surrounding the active agent has absorbed a sufficient amount of water from the aqueous solution to render the encapsulation material soft and rupturable upon application of normal usage pressure to the wipe. Advantageously, the entire encapsulation material hydrates, such that the entire encapsulation material is softened. Since the encapsulation material is not soluble in the aqueous solution, the encapsulation material does not dissolve upon hydration, but rather remains surrounding the active agent as a soft, pliable encapsulation material. Thus, once fully hydrated, the once dry, hard beads become soft and pliable, and can be ruptured (i.e., the encapsulation material broken) to release some or all of the active agent upon application of normal usage pressure to the wipe.

In the case of a wet wipe, hydration begins upon application of the wetting solution to the wipe. Because hydration occurs gradually, i.e., usually over a period of from about 5 minutes to about 45 minutes, and typically about 20 minutes, the beads are still sufficiently hard during the remainder of the converting and packaging processes to prevent the beads from prematurely rupturing. By the time the wet wipe is packaged, the beads have fully hydrated and are hydrated, rupturable beads. In the case of a substantially dry wipe, the consumer may wet the wipe with water or other aqueous solution prior to use to hydrate the beads.

Once hydrated, any means known to one of skill in the art capable of producing sufficient force to break the encapsulation material and rupture the beads can be used in the present disclosure. In one embodiment, the hydrated, rupturable beads can be broken by the user at the point of dispensing the wipe from a package. For example, a mechanical device located inside of the package containing the wipes can produce a rupture force sufficient to rupture the beads upon dispensing the wipe, thereby exposing the active agent contained within the beads.

In another embodiment, the hydrated, rupturable beads can be broken by the user just prior to or at the point of use of the wipe. By way of example, in one embodiment, the force produced by the hands of the user of the wipe can break the beads, exposing the active agent contained within the beads.

As noted above, the encapsulation material surrounds the active agent, preventing the active agent from spreading across the wipe or mixing with a wet wipe solution prior to wipe use. The encapsulation material may be any material that is capable of being dehydrated to become hard and dry, but when exposed to an aqueous solution will hydrate, becoming soft, pliable, and rupturable upon application of pressure.

Typically, the encapsulation material is a combination of a polymeric material, a crosslinked polymeric material, or a combination thereof, and a small molecule carbohydrate binder that may be used to form a shell surrounding the active agent. Specifically, suitable encapsulation materials may include cellulose-based polymeric materials (e.g., cellulose, hydroxypropyl methylcellulose, ethyl cellulose, hydroxyethylcellulose, xanthan gum, chitosan), carbohydrate-based small molecules (e.g., lactose, mannitol, xylitol, and other sugars), polyglycolic acid, polylactic acid, and lactic acid-based aliphatic polyesters, and materials derived therefrom (e.g., dextrins and cyclodextrins) as well as other materials compatible with human tissues.

Examples of suitable encapsulation materials are also available commercially and include, for example, Lipobeads™ microbeads (available from Lipo Technologies, Inc., Vandalia, Ohio), and Unispheres (available from Induchem, Volketswil, Switzerland). Lipobeads™ microbeads are a spherical, semi-solid matrix of lactose or mannitol, microcrystalline cellulose, and hydroxypropyl methylcellulose (INCI: lactose and cellulose and hydroxypropyl methylcellulose and actives and pigment). Unispheres are comprised of mannitol or lactose, cellulose, hydroxypropyl methyl cellulose, and optionally dyes and pigments. Unispheres may also contain film-forming polymers such as acrylates/ammonium methacrylate and ethylene vinyl acetate copolymers.

Typically, the active agent incorporated into the beads is a hydrophobic active agent. Non-hydrophobic active agents may also be incorporated into the beads, so long as a hydrophobic carrier fluid that is incompatible with the aqueous solution used to hydrate the beads is also incorporated into the bead along with the non-hydrophobic active agent. Non-limiting examples of suitable hydrophobic carriers include mineral oil, shea butter, coconut oil, isopropyl myristate, dimethicone, octyldodecyl neopentanoate, and combinations thereof. The specific type of active agent is not particularly limited, and may be any agent that provides a desired property to the surface being wiped. For instance, in one embodiment, the active agent may impart a perceivable aesthetic, moisturization, cleansing, or other benefit to a user's skin. In other embodiments, the wipe may be an industrial or household wipe, and the active agent may impart, for example, a cleansing or disinfecting effect to the surface being wiped, or may act to polish the surface.

In one embodiment, the active agent is an oil soluble material that is generally incompatible with an aqueous wetting solution used to form a wet wipe. Examples of suitable active agents include vitamins (e.g., vitamin A, vitamin E, vitamin D, vitamin B), vitamin esters (e.g., vitamin A palmitate, vitamin E acetate, ascorbyl palmitate), silicones (dimethicone, cyclomethicone, dimethicone crosspolymer), botanical extracts, plant oils and butters, essential oils, emollients, esters (isopropyl palmitate, triethyl citrate), antimicrobials (e.g., triclosan and chlorxylenol), fragrances, mineral oil, waxes (e.g., microcrystalline, paraffin, squalene, cholesterol), dyes, sunscreens, peptides, amino acids, marine extracts, antioxidants, self tanners, and the like.

Other suitable active agents that may be included in the beads include active agents such as neurosensory agents (agents that induce a perception of temperature change without involving an actual change in temperature such as, for example peppermint oil, eucalyptol, eucalyptus oil, methyl salicylate, camphor, tea tree oil, ketals, carboxamides, cyclohexanol derivatives, cyclohexyl derivatives, and combinations thereof), cleansing agents, appearance modifying agents (e.g., tooth whitening agents, exfoliation agents, skin-firming agents, anti-callous agents, anti-acne agents, anti-aging agents, anti-wrinkle agents, anti-dandruff agents, antiperspirant agents, wound care agents, enzyme agents, scar repair agents, colorant agents, humectant agents, hair care agents such as conditioners, styling agents, and detangling agents), powders, skin coloration agents such as tanning agents, lightening agents, and brightening agents, shine control agents and drugs), nutrients (e.g., anti-oxidants, transdermal drug delivery agents, botanical extracts, vitamins, magnets, magnetic metals, foods, and drugs), pesticides (e.g., tooth health ingredients, anti-bacterials, anti-virals, anti-fungals, preservatives, insect repellents, anti-acne agents, anti-dandruff agents, anti-parasite agents, wound care agents, and drugs), surface conditioning agents (e.g., pH adjusting agents, moisturizers, skin conditioners, exfoliation agents, shaving lubricants, skin lipids, enzymes, scar care agents, humectants, botanical extracts, and drugs), hair care agents (e.g., shaving lubricants, hair growth inhibitors, hair growth promoters, hair removers, anti-dandruff agents, colorant agents, humectants, hair care agents such as conditioners, styling agents, detangling agents, and drugs), anti-inflammatory agents (e.g., tooth health ingredients, skin conditioners, external analgesic agents, anti-irritant agents, anti-allergy agents, anti-inflammatory agents, wound care agents, transdermal drug delivery, and drugs), emotional benefit agents (e.g., gas generating agents, fragrances, odor neutralizing materials, exfoliation agents, skin-firming agents, anti-callous agents, anti-acne agents, anti-aging agents, soothing agents, calming agents, external analgesic agents, anti-wrinkle agents, anti-dandruff agents, antiperspirants, deodorants, wound care agents, scar care agents, coloring agents, botanical extracts and drugs), indicators (e.g., soil indicators), and organisms.

Additional suitable active agents include abrasive materials, abrasive slurries, acids, adhesives, alcohols, aldehydes, animal feed additives, antioxidants, appetite suppressants, bases, biocides, blowing agents, botanical extracts, candy, carbohydrates, catalysts, ceramic slurries, chalcogenides, colorants, heating agents, cooling agents, corrosion inhibitors, curing agents, detergents, dispersants, enzymes, exfoliation, fats, fertilizers, fibers, fire retardant materials, flavors, foams, food additives, fragrances, fuels, fumigants, gas forming compounds, growth regulators, gums, herbicides, herbs, spices, hormonal based compounds, humectants, hydrides, imaging materials, ingredients that are easily oxidized or not UV stable, inks, inorganic oxides, inorganic salts, insecticides, ion exchange resins, latexes, leavening agents, liquid crystals, lotions, lubricants, maltodextrins, medicines, metals, mineral supplements, monomers, nanoparticles, nematicides, nicotine-based compounds, oil recovery agents, organic solvents, paint, peptides, pesticides, pet food additives, phase change materials, phase change oils, pheromones, phosphates, pigments, dyes, plasticizers, polymers, propellants, proteins, recording materials, silicates, silicone oils, stabilizers, steroids, sugars, surfactants, suspensions, dispersions, emulsions, vitamins, warming materials, waste treatment materials, adsorbents, water insoluble salts, water treatment materials, waxes, and yeasts.

Typically, the beads will comprise active agent in an amount of from about 0.5% (by total weight of the bead) to about 35% (by total weight of the bead), and more preferably, in an amount of from about 1% (by total weight of the bead) to about 25% (by total weight of the bead).

The wipes of the present disclosure may comprise beads containing a single type of active agent in all beads incorporated into the wipe. Alternately, a wipe may comprise beads containing two or more different active agents. For instance, in one embodiment, a wipe may comprise a first bead comprising a first active agent, a second bead comprising a second active agent, and optionally one or more additional beads containing one or more additional active agents. The first active agent and second active agent may both impart a similar benefit to the wipe user, e.g., the first and second active agents may both be moisturizers. Alternately, the first active agent and second active agent may have differing effects, e.g., one may be a sunscreen agent and one may be a moisturizing agent, resulting in a wipe that may impart multiple benefits to the user.

In certain embodiments, the beads may be colored using a coloring agent prior to incorporating the dehydrated beads into the fibrous sheet material. The coloring of the beads can improve the aesthetics of the wipe. Additionally, the coloring of the beads can be used to communicate to the consumer the presence and function of the active agent(s). For example, if the active agent is aloe, the beads may be colored blue-green, which is typically associated with aloe. Additionally, the coloring of the beads can direct the consumer of the wipe product to the location of the beads in the wipe. The wipes of the present disclosure may comprise only beads of a single color or, alternately, may comprise beads of two or more different colors, depending on the desired look of the wipe.

Suitable coloring agents include, for example, dyes, color additives, and pigments or lakes. Suitable dyes include, for example, Blue 1, Blue 4, Brown 1, External Violet 2, External Violet 7, Green 3, Green 5, Green 8, Orange 4, Orange 5, Orange 10, Orange 11, Red 4, Red 6, Red 7, Red 17, Red 21, Red 22, Red 27, Red 28, Red 30, Red 31, Red 33, Red 34, Red 36, Red 40, Violet 2, Yellow 5, Yellow 6, Yellow 7, Yellow 8, Yellow 10, Yellow 11, Acid Red 195, Anthocyanins, Beetroot Red, Bromocresol Green, Bromothymol Blue, Capsanthin/Capsorubin, Curcumin, and Lactoflavin. Also, many dyes found suitable for use in the European Union and in Japan may be suitable for use as coloring agents in the present disclosure.

Suitable color additives include, for example, aluminum powder, annatto, bismuth citrate, bismuth oxychloride, bronze powder, caramel, carmine, beta carotene, chloraphyllin-copper complex, chromium hydroxide green, chromium oxide greens, copper powder, disodium EDTA-copper, ferric ammonium ferrocyanide, ferric ferrocyanide, guauazulene, guanine, henna, iron oxides, lead acetate, manganese violet, pyrophylite, ultramarines, silver, and metal oxides such as titanium dioxide, zinc oxide, mica, iron oxides, and the like, and combinations thereof.

Suitable pigments or lakes include, for example, Blue 1 Lake, External Yellow 7 Lake, Green 3 Lake, Orange 4 Lake, Orange 5 Lake, Orange 10 Lake, Red 4 Lake, Red 6 Lake, Red 7 Lake, Red 21 Lake, Red 22 Lake, Red 27 Lake, Red 28 Lake, Red 30 Lake, Red 31 Lake, Red 33 Lake, Red 36 Lake, Red 40 Lake, Yellow 5 Lake, Yellow 6 Lake, Yellow 7 Lake, Yellow 10 Lake, and combinations thereof.

The size of the beads is not critical, but typically is such that the beads are compatible with the thickness of the fibrous sheet material. Additionally, bead size may vary, depending on the intended use of the wipe. For instance, smaller bead sizes are more conducive for a product that is intended to come in contact with the skin, whereas larger bead sizes may be used for a product that is intended to come in contact with hard surfaces.

Typically, the beads have a diameter of from about 250 micrometers to about 1500 micrometers, and more typically from about 600 micrometers to about 1250 micrometers. In one embodiments, the beads may have a diameter of from about 600 micrometers to about 800 micrometers. In another embodiment, the beads may have a diameter of from about 1050 micrometers to about 1250 micrometers.

The beads as described herein are suitable for use in a number of personal care products, including wipe products, wraps, such as medical wraps and bandages, paper towels, and the like. Although described primarily herein in relation the wipes, it will be recognized by one skilled in the art that the beads described herein could be incorporated into any one or more of the other products listed above, using the techniques described herein.

Generally, the wipes of the present disclosure including the hydrated, rupturable beads or the dehydrated beads can be wet wipes, substantially dry wipes, or semi-dry wipes. As used herein, the term “wet wipe” means a wipe that includes greater than about 70% (by weight fibrous sheet material) moisture content. As used herein, the term “substantially dry wipe” means a wipe that includes less than about 10% (by weight fibrous sheet material) moisture content. As used herein, the term “semi-dry” wipe means a wipe that includes between about 10% (by weight fibrous sheet material) and about 70% (by weight fibrous sheet material) moisture content. Specifically, suitable wipes for use in the present disclosure can include wet wipes, substantially dry wipes, semi-dry wipes, hand wipes, face wipes, cosmetic wipes, household wipes, industrial wipes, and the like. Particularly preferred wipes are wet wipes, and other wipe-types that include a solution.

Materials suitable for the substrate of the wipes are well know to those skilled in the art, and are typically made from a fibrous sheet material which may be either woven or nonwoven. For example, suitable materials for use in the wipes may include nonwoven fibrous sheet materials which include meltblown, coform, air-laid, bonded-carded web materials, spunlace, hydroentangled materials, and combinations thereof. Such materials can be comprised of synthetic or natural fibers, or a combination thereof. Typically, the wipes of the present disclosure define a basis weight of from about 175 grams per square meter to about 500 grams per square meter and desirably from about 200 grams per square meter to about 400 grams per square meter.

The wipes of the present disclosure can comprise a fibrous sheet material that is a single layer of material, or alternately may comprise a fibrous sheet material that is a composite which includes multiple layers of materials.

In one embodiment, the beads are embedded within the interior of a single layer of material. The single layer of material having the beads embedded therein may then be used as a single-layer fibrous sheet material. In embodiments where the beads are embedded within the interior of a single layer of material, the material will typically comprise a non-woven material such as coform, airlaid, meltblown, or the like.

In another embodiment, the beads are located in between two or more layers of a multiple-layer fibrous sheet material. For instance, two or more layers of material may be laminated, plied, or otherwise adhered together to form a composite comprising multiple-layers of materials, as described hereinafter. In one embodiment, the beads are sandwiched between two or more of the layers of the composite. In certain instances, a single layer of material having the beads embedded therein, as described above, may be incorporated into the composite.

In embodiments where the fibrous sheet material is a composite which includes multiple layers of material, the fibrous sheet material may comprise any suitable woven or non-woven material, such as meltblown, coform, air-laid, bonded-carded web materials, spunlace, hydroentangled materials, and combinations thereof. For example, the wipes may include a three layer composite which includes an elastomeric film or meltblown layer between two coform layers as described hereinafter. In such a configuration, the coform layers may define a basis weight of from about 15 grams per square meter to about 30 grams per square meter and the elastomeric layer may include a film material such as a polyethylene metallocene film. Such composites are manufactured generally as described in U.S. Pat. No. 6,946,413, issued to Lange, et al. (Sep. 20, 2005), which is hereby incorporated by reference to the extent it is consistent herewith. The beads may be incorporated into the composite fibrous sheet material by embedding the beads within one or more of the layers and/or by sandwiching the beads between layers of the fibrous sheet material, as described herein.

In one particular embodiment, the wipes of the present disclosure comprise a coform basesheet of polymer fibers and absorbent fibers having a basis weight of from about 60 to about 80 grams per square meter and desirably about 75 grams per square meter. Such coform basesheets are manufactured generally as described in U.S. Pat. No. 4,100,324, issued to Anderson, et al. (Jul. 11, 1978); U.S. Pat. No. 5,284,703, issued to Everhart, et al. (Feb. 8, 1994); and U.S. Pat. No. 5,350,624, issued to Georger, et al. (Sep. 27, 1994), which are incorporated by reference to the extent to which they are consistent herewith. Typically, such coform basesheets comprise a gas-formed matrix of thermoplastic polymeric meltblown fibers and cellulosic fibers. Various suitable materials may be used to provide the polymeric meltblown fibers, such as, for example, polypropylene microfibers. Alternatively, the polymeric meltblown fibers may be elastomeric polymer fibers, such as those provided by a polymer resin. For instance, Vistamaxx® elastic olefin copolymer resin designated PLTD-1810, available from ExxonMobil Corporation (Houston, Tex.) or KRATON G-2755, available from Kraton Polymers (Houston, Tex.) may be used to provide stretchable polymeric meltblown fibers for the coform basesheets. Other suitable polymeric materials or combinations thereof may alternatively be utilized as known in the art.

As noted above, the coform basesheet additionally may comprise various absorbent cellulosic fibers, such as, for example, wood pulp fibers or staple fibers. Suitable commercially available cellulosic fibers for use in the coform basesheets can include, for example, NF 405, which is a chemically treated bleached southern softwood Kraft pulp, available from Weyerhaeuser Co. of Federal Way (Wash.); NB 416, which is a bleached southern softwood Kraft pulp, available from Weyerhaeuser Co.; CR-0056, which is a fully debonded softwood pulp, available from Bowater, Inc. (Greenville, S.C.); Golden Isles 4822 debonded softwood pulp, available from Koch Cellulose (Brunswick, Ga.); and SULPHATATE HJ, which is a chemically modified hardwood pulp, available from Rayonier, Inc. (Jesup, Ga.).

The relative percentages of the polymeric meltblown fibers and cellulosic fibers in the coform basesheet can vary over a wide range depending upon the desired characteristics of the wipes. For example, the coform basesheet may comprise from about 10 weight percent to about 90 weight percent, desirably from about 20 weight percent to about 60 weight percent, and more desirably from about 25 weight percent to about 35 weight percent of the polymeric meltblown fibers based on the dry weight of the coform basesheet being used to provide the wipes.

“Airlaid” refers to a porous web formed by dispersing fibers in a moving air stream prior to collecting the fibers on a forming surface. The collected fibers are then typically bonded to one another using, for example, hot air or a spray adhesive. Suitable examples of airlaid webs can be found in U.S. Pat. No. 5,486,166 to Bishop, et al., U.S. Pat. No. 6,960,349, issued to Shantz, et al. (Nov. 1, 2005), and U.S. Publication No. 2006/0008621 to Gusky, et al., all incorporated by reference to the extent that they are consistent herewith.

The fibrous sheet material may also comprise meltblown materials. “Meltblown” refers to fibers formed by extruding a molten thermoplastic material through a plurality of fine, usually circular, die capillaries as molten threads or filaments into converging high velocity gas (e.g., air) streams, generally heated, which attenuate the filaments of molten thermoplastic material to reduce their diameters. Thereafter, the meltblown fibers are carried by the high velocity gas stream and are deposited on a collecting surface or support to form a web of randomly dispersed meltblown fibers. Such a process is disclosed, for example, in U.S. Pat. No. 3,849,241 to Butin et al. Meltblowing processes can be used to make fibers of various dimensions, including macrofibers (with average diameters from about 40 to about 100 microns), textile-type fibers (with average diameters between about 10 and 40 microns), and microfibers (with average diameters less than about 10 microns). Meltblowing processes are particularly suited to making microfibers, including ultra-fine microfibers (with an average diameter of about 3 microns or less). A description of an exemplary process of making ultra-fine microfibers may be found in, for example, U.S. Pat. No. 5,213,881 to Timmons, et al. Meltblown fibers may be continuous or discontinuous and are generally self bonding when deposited onto a collecting surface.

“Spunbonded fibers” refers to small diameter fibers which are formed by extruding molten thermoplastic material as filaments from a plurality of fine, usually circular capillaries of a spinneret with the diameter of the extruded filaments then being rapidly reduced to fibers as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al., the contents of which are incorporated herein by reference in their entirety. Spunbond fibers are generally continuous and have diameters generally greater than about 7 microns, more particularly, between about 10 and about 20 microns.

“Bonded-carded web” refers to a web made from staple fibers sent through a combing or carding unit, which separates or breaks apart and aligns the fibers to form a nonwoven web. For example, the web may be a powder bonded carded web, an infrared bonded carded web, or a through-air bonded carded web. Examples of such materials may be found in U.S. Pat. Nos. 5,490,846 to Ellis et al.; 5,364,382 to Latimer; and 6,958,103 to Anderson, et al.

“Spunlace” refers to a means of bonding a web and involves entangling the fibers with high-pressure liquid jets along closely-spaced parallel lines. There are typically no bonding agents involved. Examples of spunlace materials include those described in U.S. Pat. Nos. 3,560,326 to Bunting, Jr., et al. and 3,485,706 to Evans.

As noted above, the beads are initially incorporated into the fibrous sheet material as dehydrated beads. The dehydrated beads are advantageously embedded within the interior of the fibrous sheet material that makes up the wipe basesheet or substrate. By embedding the dehydrated beads into the interior of the fibrous sheet material, the beads will more readily be retained in the wipe and will not stick to other wipes or the wipe container once hydrated to the extent they would if the beads were applied to the surface of the fibrous sheet material or incorporated into a wetting solution. Additionally, the wipe will have a reduced grittiness feel because when the beads rupture during wipe use, their shells will not come into direct contact with the user's skin. Additionally, when the bead is located in the interior of the fibrous sheet material, the bead is better protected from premature rupture and release of the active agent caused by the conditions of manufacturing, storage, and transportation of the wipe.

The techniques used to embed the dehydrated beads within the interior of the fibrous sheet material may vary depending on the composition of the fibrous sheet material.

For example, in one specific embodiment, the fibrous sheet material is one or more meltblown layers made by providing a stream of extruded molten polymeric fibers. To incorporate the beads, a stream of dehydrated beads can be merged with the stream of extruded molten polymeric fibers and collected on a forming surface such as a forming belt or forming drum to form the wipe comprising the dehydrated beads. Optionally, a forming layer can be placed on the forming surface and used to collect the dehydrated beads in the wipe. By using this method, the dehydrated bead is mechanically entrapped within the forming layer.

The stream of meltblown polymeric fibers may be provided by meltblowing a copolymer resin or other polymer. For example, in one embodiment, the melt temperature for a copolymer resin such as Vistamaxx® PLTD 1810 can be from about 450° F. (232° C.) to about 540° F. (282° C.). As noted above, suitable techniques for producing nonwoven fibrous webs, which include meltblown fibers, are described in the previously incorporated U.S. Pat. Nos. 4,100,324 and 5,350,624. The meltblowing techniques can be readily adjusted in accordance with the knowledge of one skilled in the art to provide turbulent flows that can operatively intermix the fibers and the dehydrated beads. For example, the primary air pressure may be set at 5 pounds per square inch (psi) and the meltblown nozzles may be 0.020 inch spinneret hole nozzles.

Additionally, immediately following the formation of the meltblown structure, the meltblown polymeric fibers can be tacky, which can be adjusted to provide additional adhesiveness between the fibers and the dehydrated beads.

In another embodiment, the fibrous sheet material is a coform basesheet comprising a matrix of thermoplastic polymeric meltblown fibers and absorbent cellulosic fibers. Similar to the meltblown embodiment above, when the fibrous sheet material is a matrix of thermoplastic polymeric meltblown fibers and absorbent cellulosic fibers, a stream of dehydrated beads can be merged with a stream of cellulosic fibers and a stream of polymeric fibers into a single stream and collected on a forming surface such as a forming belt or forming drum to form a wipe comprising a fibrous sheet material with the dehydrated beads within its interior.

The stream of absorbent cellulosic fibers may be provided by feeding a pulp sheet into a fiberizer, hammermill, or similar device as is known in the art. Suitable fiberizers are available from Hollingsworth (Greenville, S.C.) and are described in U.S. Pat. No. 4,375,448, issued to Appel, et al. (Mar. 1, 1983), which is incorporated by reference to the extent to which it is consistent herewith. The stream of polymeric fibers can be provided as described above.

In another embodiment, the fibrous sheet material is an air-laid substrate. Airlaid substrates may be formed using any conventional air-forming device. Such air-forming devices are well known to those skilled in the art for use informing fibrous webs. For example, reference is made to U.S. Pat. Nos. 4,666,647, issued May 19, 1987 to Enloe, et al., and U.S. Pat. No. 4,761,258 issued Aug. 2, 1988 to Enloe, the disclosures of which are incorporated herein by reference to the extent that they are consistent herewith. In such devices, fibrous material is introduced and may be mixed with other material such as dehydrated beads, as described herein, prior to collecting on the forming surface. The dehydrated beads may be mixed with the fibrous material by using a particulate feeder to drop the beads into the fibrous material. Particulate feeders are commercially available and include those sold by Santex. A pneumatic flow mechanism, such as a vacuum suction system, draws the air-entrained fiber stream within the air-forming device toward the forming surface so that air passes through the foraminous surface while the fibers and other air-entrained material collect on the forming surface, forming an air-laid substrate with beads intermixed with the fibers.

The thickness of the fibrous sheet material will typically depend upon the diameter size of the beads, the fibrous sheet material basis weight, and the bead loading. For example, as the size of the bead is increased, the fibrous sheet material must be thicker to prevent the wipe from having a gritty feel.

In another embodiment, the fibrous sheet material is a composite material that is made up of more than one layer. Each layer may comprise the same type of substrate material, or may comprise two or more different substrate materials. For example, the fibrous sheet material may be a meltblown material, which can suitably be made up of two meltblown layers secured together, more suitably three meltblown layers, even more suitably four meltblown layers, and even more suitably five or more meltblown layers. Alternately, the fibrous sheet material may be a coform basesheet suitably made up of two coform basesheet layers secured together, more suitably three coform basesheet layers, even more suitably four coform basesheet layers, even more suitably five or more coform basesheet layers. Moreover, the fibrous sheet material can includes a film suitably made up of two film layers, more suitably three film layers, even more suitably four film layers, and even more suitably five or more film layers. In one embodiment, the layers are separate layers. In another embodiment, the layers are plied together.

In other embodiments, the fibrous sheet material can be made up of more than one layer, with the layers of the fibrous sheet material comprising two or more different materials, such as meltblown, coform, air-laid, bonded-carded web materials, spunlace, hydroentangled materials, and combinations thereof. For example, the fibrous sheet material may comprise a meltblown layer between two coform layers. Other combinations may also be used.

In one embodiment, the beads are located in between two or more layers of the fibrous sheet material. Using the additional layers will allow for improved capture of the dehydrated beads. This helps to ensure the dehydrated beads will remain in the wipe during shipping and storage. Additionally, as the dehydrated beads become further entrapped in the fibrous sheet material, the grittiness of the wipe is reduced.

In one embodiment, to incorporate the beads in between the layers of fibrous sheet material, the beads are sandwiched between a first layer and a second layer of the fibrous sheet material, and the layers are then laminated or otherwise secured together using any means known in the art. In certain embodiments, the dehydrated beads may also be sandwiched between more than two layers of the fibrous sheet material. For instance, a first bead may be sandwiched between a first and a second layer of the fibrous sheet material, while a second bead may be sandwiched between the second layer and a third layer of the fibrous sheet material, with all the layers then being laminated or otherwise secured together. The first and second beads may be the same type of beads, or alternately, may be different beads. For instance, in one embodiment, the first bead comprises a first active agent, while the second bead comprises a second active agent. It is to be understood that one or more additional beads may be sandwiched between one or more additional layers of a fibrous sheet material in a similar manner.

In another embodiment, a layer of material having dehydrated beads embedded within the interior of the layer may be laminated or otherwise secured to one or more additional layers of material. For instance, a coform material having dehydrated beads embedded within the interior of the coform material may be laminated or otherwise secured to one or more additional layers of coform material or other suitable materials to form a multi-layered fibrous sheet material.

Thus, in one embodiment, the fibrous sheet material may comprise at least a first layer and a second layer, with dehydrated beads being embedded within the first and/or second layers. Optionally, dehydrated beads may also be sandwiched between the first and second layers, as described above.

In another embodiment, the fibrous sheet material may comprise three, four, or more layers, with some or all of the layers having dehydrated beads embedded therein. Optionally, dehydrated beads may also be sandwiched between any or all of these layers.

The beads embedded within each layer and/or sandwiched between the layers may be the same type of beads, or alternately may be different beads. For example, in one embodiment, the fibrous substrate comprises a first layer, a second layer adjacent the first layer, a third layer adjacent to the second layer, and a fourth layer adjacent to the third layer, wherein a first group of beads comprising a first active agent is embedded within the second layer and a second group of beads comprising a second active agent is embedded within the third layer. As noted above, beads may also be sandwiched between any of the layers. Other suitable combinations of layers and beads may also be used.

Any suitable method may be used to secure the layers of the fibrous sheet material together. For example, the layers can be secured together thermally, by a suitable laminating adhesive composition, or by allowing the layers to entangle, as described above, trapping the beads between the layers.

Thermal bonding includes continuous or discontinuous bonding using a heated roll. Point bonding is one suitable example of such a technique. Thermal bonds should also be understood to include various ultrasonic, microwave, and other bonding methods wherein the heat is generated in the non-woven or the film.

In a preferred embodiment, the first layer, second layer, and any additional layers are laminated together using a water insoluble adhesive composition. Suitable water insoluble adhesive compositions can include hot melt adhesives and latex adhesives as described in U.S. Pat. No. 6,550,633, issued to Huang, et al. (Apr. 22, 2003); U.S. Pat. No. 6,838,154, issued to Anderson, et al. (Oct. 25, 2005); and U.S. Pat. No. 6,958,103, issued to Varona et al. (Jan. 4, 2005), which are hereby incorporated by reference to the extent they are consistent herewith. Suitable hot melt adhesives can include, for example, RT 2730 APAO and RT 2715 APAO, which are amorphous polyalphaolefin adhesives (commercially available from Huntsman Polymers Corporation, Odessa, Tex.) and H2800, H2727A, and H2525A, which are all styrenic block copolymers (commercially available from Bostik Findley, Inc., Wauwatosa, Wis.). Suitable latex adhesives include, for example, DUR-O-SET E-200 (commercially available from National Starch and Chemical Co., Ltd., Bridgewater, N.J.) and Hycar 26684 (commercially available from B.F. Goodrich, Laval, Quebec).

The water insoluble adhesive composition can additionally be used in combination with beads sandwiched between the first, second, and any additional layers of the fibrous sheet material. The water insoluble adhesive composition will provide improved binding of the beads to the first, second, and any additional layers of the fibrous sheet material. Typically, the adhesive composition can be applied to the desired area by spraying, knifing, roller coating, or any other means suitable in the art for applying adhesive compositions.

Suitably, the adhesive composition can be applied to the desired area of the wipe in an amount of from about 0.01 grams per square meter to about 20 grams per square meter. More suitably, the adhesive composition can be applied in an amount of from about 0.05 grams per square meter to about 0.5 grams per square meter.

In yet another embodiment, the dehydrated beads may be distributed within a pocket of the fibrous sheet material. Similar to the pattern distribution method described herein below, the pockets of dehydrated beads provide for a targeted delivery of active agent in the wipe.

The dehydrated beads may be embedded in the fibrous sheet material in a continuous layer or a patterned layer. By using a patterned layer, a targeted delivery of active agent can be achieved. These methods of distribution can additionally reduce manufacturing costs as reduced amounts of beads are required. Suitably, the beads can be distributed in patterns including, for example, characters, an array of separate lines, swirls, numbers, or dots of beads. Continuous patterns, such as stripes or separate lines that run parallel with the machine direction of the web, are particularly preferred as these patterns may be more process-friendly.

The wipes of the present disclosure suitably comprise beads in an amount of from about 0.5% (by weight of the fibrous sheet material) to about 80% (by weight of the fibrous sheet material). More suitably, the wipes comprise the beads in an amount of from about 15% (by weight of the fibrous sheet material) to about 30% (by weight of the fibrous sheet material).

Once the dehydrated beads have been embedded within the interior of the fibrous sheet material, the wipe may be fed into a converting machine for rolling, folding, packaging, and any further treatment, such as addition of a wetting solution, to produce a personal care product, such as a wipe product. The converting process may be any conventional converting process known in the art.

In one embodiment, the wipe is a substantially dry wipe or a semi-dry wipe. In the case of a semi-dry wipe, an amount of a wetting solution sufficient to hydrate the beads is applied to the wipe prior to packaging, so that the beads are fully hydrated when the wipe is removed from its packaging. The consumer may further wet the semi-dry wipe with an aqueous solution just prior to, or at the point of use, of the wipe, but this is not required to hydrate the beads. In the case of a substantially dry wipe, the substantially dry wipe can be wetted with an aqueous solution just prior to, or at the point of, use of the wipe. The aqueous solution can be any aqueous solution known in the art to be suitable for use in wipe products. Generally, the aqueous solution includes mainly water, and can further include additional components, such as cleansers, lotions, preservatives, fragrances, surfactants, emulsifiers, and combinations thereof. Once the wipe is wetted with the aqueous solution, the beads will hydrate, becoming soft, rupturable beads. The wipe is then used by a consumer. The use of the wipe results in rupture of the hydrated, rupturable beads embedded within the wipe, whereupon the active agent is released from the beads and may contact the skin or other surface being wiped.

In another embodiment, the wipe is a wet wipe comprising a wetting solution in addition to the fibrous sheet material and the beads. Addition of the wetting solution to the wet wipe causes the dehydrated beads to begin hydration. By the time the wipes are packaged, hydration is complete, and the dehydrated beads have hydrated to become hydrated, rupturable beads. When the beads are ruptured, their contents contact the wetting solution of the wet wipe, and may readily be spread onto the skin or other surface being wiped.

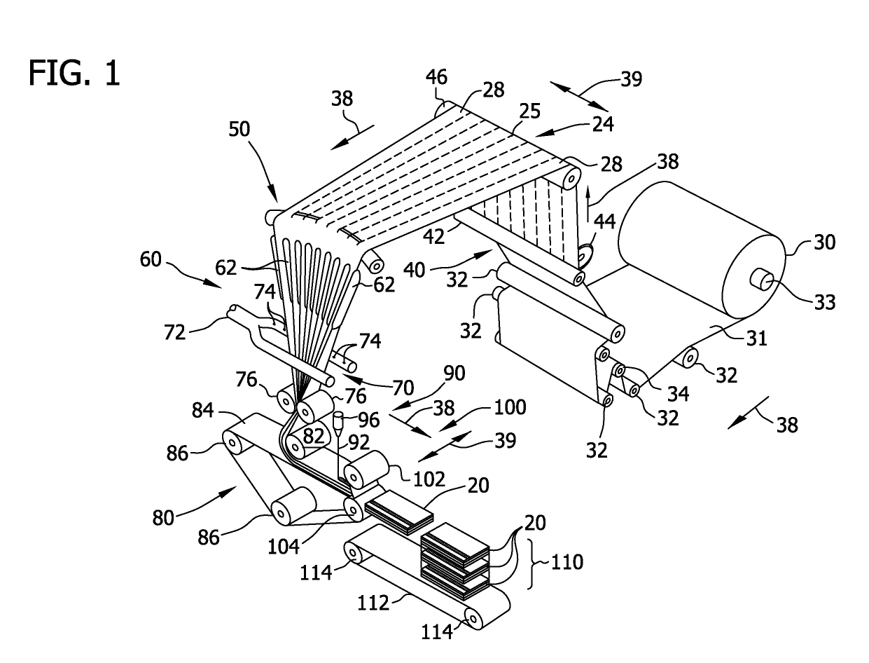

A typical converting process for a wipe product is shown in FIG. 1. Specifically, a roll 30 of fibrous sheet material 31 having dehydrated beads embedded within the interior of the fibrous sheet material is supported by a roll support 33. The fibrous sheet material 31 is fed through a series of advancing rollers such as idler rollers 32 and dancer roller 34. While FIG. 1 depicts rolling the fibrous sheet material using at least one roller, it should be understood by one skilled in the art that the fibrous sheet material may advance through the converting process using more than one roller, such as two rollers, or three rollers, or even four rollers or more. Furthermore, one skilled in the art should recognize that, while FIG. 1 shows using rollers for advancing the fibrous sheet material, devices other than rollers may be used, such as, for example, one or more driven belt sets without departing from the scope of the present disclosure. Specifically, in one alternative embodiment, the fibrous sheet material is rolled through a first set of driven belts and a second set of driven belts. The first set of drive belts is typically configured to contact a first side of the fibrous sheet material and the second set of drive belts is typically configured to contact a second opposing side of the fibrous sheet material.

From there the fibrous sheet material travels over an upper idler roller 46 and over to an arched roller assembly 50. The rolled fibrous sheet material then travels into the folding assembly 60. The folding assembly includes a series of folding devices 62 that assist in folding the rolled fibrous sheet material in the cross direction 39 in a controlled fashion to induce machine direction 38 folds. As the rolled fibrous sheet material travels further down the folding assembly, the fibrous sheet material becomes corrugated to a point where the fibrous sheet material is compressed in the cross direction by means of nip rollers 76. At this point, the rolled stretched substrate material forms a single ribbon of fan folded sheets that then travels by a conveyor assembly 80 including a pull roller 82, support belt 84 and support rollers 86 which are an idler roller and a drive roller.

In one particularly preferred embodiment, as shown in FIG. 1, the rolled fibrous sheet material 31 may further travel to a slitter assembly 40 where the rolled fibrous sheet material is slit prior to folding the fibrous sheet material. The slitter assembly can include an anvil roller 42 and slitting blades 44 that form weakened lines 24 (e.g., perforated slitting blades that thereby form perforations 25) in the rolled fibrous sheet material as it travels in the machine direction 38 through the slitting assembly. As a result of traveling through the slitting assembly, the rolled fibrous sheet material is formed into a plurality of panels 28 joined to adjacent panels along the plurality of weakened lines 24.

In another particularly preferred embodiment, in which the personal care product is a wet wipe or semi-dry wipe, as the rolled fibrous sheet material, which may have been slit or not, travels down the folding assembly 60, where it encounters a moistening assembly 70. Assembly 70 can include a bar 72 having ports 74 for imparting a liquid or solution onto the moving rolled fibrous sheet material as it is folded into a fan folded ribbon of material.

A liquid or wetting solution can be provided at a desired add-on rate and in a conventional manner to the bar 72 so it can be deposited through ports 74 to the moving rolled fibrous sheet material. Such deposition of the liquid or solution could include spraying or drooling with a bar like 72, or could include alternate structures (not shown) for techniques such as printing, a bath, a flooded nip, or hollowed out folding devices with spray orifices that project fluid in a rather even horizontal plane as the rolled fibrous sheet material moves by the devices.

When the wipe is a wet wipe, typically when a liquid or wetting solution is deposited onto the rolled fibrous sheet material, the solution is deposited in an amount of from about 150% (by total weight fibrous sheet material) to about 600% (by total weight fibrous sheet material). More suitably, the wetting solution is deposited in an amount of from about 250% (by total weight fibrous sheet material) to about 350% (by total weight fibrous sheet material). When the wipe is a semi-dry wipe, the liquid or wetting solution is typically deposited onto the rolled fibrous sheet material in an amount sufficient to hydrate the dehydrated beads, typically in an amount of between about 10% (by total weight fibrous sheet material) and about 70% (by total weight fibrous sheet material).

When the liquid or wetting solution is applied to the fibrous sheet material to form a wet wipe or semi-dry wipe, the dehydrated beads embedded within the interior of the fibrous sheet material slowly begin to hydrate. Thus, by the time the conversion process is complete, the once dehydrated, hard beads have become hydrated and rupturable. Hydration typically takes from about 5 minutes to about 45 minutes, and more typically is completed after about 20 minutes.

A typical liquid or wetting solution is a wet wipe formulation including water, emollients, surfactants, preservatives, chelating agents, pH adjusting agents, skin conditioners, fragrances, and combinations thereof. For example, one suitable wetting solution for use in the wet wipe or semi-dry wipe of the present disclosure comprises about 98% (by weight) water, about 0.6% (by weight) surfactant, about 0.3% (by weight) humectant, about 0.3% (by weight) emulsifier, about 0.2% (by weight) chelating agent, about 0.35% (by weight) preservative, about 0.002% (by weight) skin conditioning agent, about 0.03% (by weight) fragrance, and about 0.07% (by weight) pH adjusting agent. One specific wetting solution suitable for use in the wet wipe of the present disclosure is described in U.S. Pat. No. 6,673,358, issued to Cole et al. (Jan. 6, 2004), which is incorporated herein by reference to the extent it is consistent herewith.

Alternatively, if a dry final product (e.g., substantially dry wipe) is desired, the moistening assembly can be eliminated and otherwise the manufacturing apparatus and process could be the same.

In one embodiment, as shown in FIG. 1, the folded fibrous sheet material may further continue to travel to an adhesive application assembly 90. The adhesive assembly applies adhesive 92 via an adhesive nozzle 96 to the top of the ribbon, e.g., along an edge of the folded fibrous sheet material. One particularly preferred adhesive is a hot melt adhesive such as is commercially available under the tradename RT 2730 APAO (Huntsman Polymers Corporation, Odessa, Tex.). Typically, the amount of adhesive applied to the folded fibrous sheet material can be any suitable amount known in the art. For example, the adhesive can suitably be applied to the folded fibrous sheet material in an amount of from about 0.1 milligrams of adhesive per clip (as described below) to about 5.0 milligrams of adhesive per clip. Even more suitably, the adhesive can be applied to the folded fibrous sheet material in an amount of from about 0.3 milligrams of adhesive per clip to about 1.2 milligrams of adhesive per clip. In one particularly preferred embodiment, about 0.6 milligrams of adhesive is applied per clip (as described below) of folded fibrous sheet material.

Adhesive can be applied by various techniques known to those of skill in the art. For example, when the sheets comprise wet wipes, some such ways are described in a U.S. Pat. No. 6,550,633, issued to Huang, et al. (Apr. 22, 2003), which is assigned to the same assignee of this application and is incorporated herein by reference to the extent it is consistent herewith.

Additionally, as shown in FIG. 1, the folded fibrous sheet material, with adhesive applied thereto, may travel on to a cutter assembly 100, which includes a rotary cutter 102 and anvil roller 104. The fibrous sheet material is then cut into discreet pieces, called clips 20, which then pass to a stacker assembly 110. The stacker assembly includes a stacker belt 112 and stacker rollers 114 which are an idler roller and a drive roller. In the stacker assembly 110, the clips 20 are stacked one upon the other and thereby the adhesive 92 on the top sheet of a clip adheres to a bottom sheet of the subsequent clip that is stacked on top of it. A desired number of clips are stacked one on top of another and adhesively joined in this manner. An example of such an apparatus for use as the stacker assembly is provided with a variety of conventional wet wipe machines sold by Paper Converting Machine Company of 2300 S. Ashland Ave., Green Bay, Wis. 54307, under the tradename Triton™ Wet Wipes Machine. Other stackers that could be employed are those supplied with a ZFV™ folder, sold by Elsner Engineering of Hanover, Pa. USA or a Serv-O-Tec™ folder sold by Serv-O-Tec in Lagenfeld Germany (Serv-O-Tec is a division of Bretting Mfg. in Ashland Wis., USA). Then, the completed stack is moved to a packaging assembly (not shown) where the clips can be put in various types of dispensers (e.g., tubs, bags, etc.) and then made ready for commercial sale and use.

### EXAMPLES

### Example

In this example, 2-layered coform basesheets incorporating varying amounts of dehydrated beads were formed.

Dehydrated beads comprising 10% (by weight of the bead) mineral oil, and having an encapsulation material comprising mannitol, microcrystalline cellulose, hydroxypropyl methyl cellulose, ferric ferrocyanide, and chromium hydroxide green were used. To begin, the dehydrated beads were sprinkled by hand onto a single layer coform basesheet comprising a blend of an elastic olefin polymer and a wood pulp fiber and having a basis weight of 35 gsm, in an add-on amount of either 0.5% (by weight of the basesheet), 1% (by weight of the basesheet), 5% (by weight of the basesheet), 15% (by weight of the basesheet), or 20% (by weight of the basesheet). The single layer coform basesheet comprising the dehydrated beads was then adhesively bonded to a second single layer of the same coform basesheet using 0.5 to 0.7% (by weight of the substrate) of 3M Multipurpose spray adhesive. The resulting basehseet was a 2-layered, adhesively bonded basesheet containing dehydrated beads sandwiched between the two layers of basesheet.

A wetting solution used on HUGGIES® wet wipes (commercially available from Kimberly-Clark Corporation) was applied to the basesheets to form wet wipes.

The coform basesheets produced using this example are suitable for use as wipe basesheets in wet wipes, dry wipes, or semi-dry wipes.

Having described the disclosure in detail, it will be apparent that modifications and variations are possible without departing from the scope of the disclosure defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above compositions and products without departing from the scope of the disclosure, it is intended that all matter contained in the above description shall be interpreted as illustrative and not in a limiting sense.

What is claimed is:

1. A wet wipe comprising:
a fibrous sheet material,
a wetting solution, and
a hydrated, rupturable bead comprising an active agent and an encapsulation material that surrounds the active agent,
wherein the hydrated rupturable bead is embedded within the interior of the fibrous sheet material.

2. The wet wipe of claim 1 wherein the fibrous sheet material comprises a nonwoven selected from the group consisting of a meltblown material, a coform material, an air-laid material, a bonded-carded web material, a hydroentangled material, spunlace, and combinations thereof.

3. The wet wipe of claim 1 wherein the fibrous sheet material comprises at least a first layer and a second layer, and wherein the rupturable beads are located in between the first layer and the second layer.

4. The wet wipe of claim 3 wherein the first layer and the second layer are plied together, laminated together, or secured together using thermal bonding.

5. The wet wipe of claim 3 further comprising at least a third layer adjacent to the second layer.

6. The wet wipe of claim 5 wherein the hydrated, rupturable bead is embedded within the interior of the second layer.

7. The wet wipe of claim 5 further comprising at least a fourth layer adjacent to the third layer, wherein the second layer comprises a first hydrated, rupturable bead comprising a first active agent embedded within the second layer and the third layer comprises a second hydrated, rupturable bead comprising a second active agent embedded within the third layer.

8. The wet wipe of claim 1 wherein the fibrous sheet material is a single layer.

9. The wet wipe of claim 1 wherein the hydrated, rupturable bead is embedded within the interior of the fibrous sheet material in a pattern.

10. The wet wipe of claim 1 wherein the hydrated, rupturable bead is distributed within a pocket in the fibrous sheet material.

11. The wet wipe of claim 1 wherein the hydrated, rupturable bead has a diameter of from about 250 micrometers to about 1500 micrometers.

12. The wet wipe of claim 1 wherein the encapsulation material comprises lactose, cellulose, and hydroxypropyl methylcellulose.

13. The wet wipe of claim 1 wherein the encapsulation material comprises mannitol, cellulose, and hydroxypropyl methylcellulose.

14. The wet wipe of claim 1 wherein the hydrated, rupturable bead further comprises a coloring agent.

15. The wet wipe of claim 1 wherein the hydrated rupturable bead comprises from about 0.5% (by weight of the bead) to about 25% (by weight of the bead) of active agent.

16. The wet wipe of claim 1 wherein the active agent is selected from the group consisting of vitamins, vitamin esters, botanical extracts, plant oils and butters, essential oils, emollients, esters, antimicrobials, fragrances, mineral oil, waxes, dyes, sunscreens, peptides, amino acids, marine extracts, antioxidants, self tanners, and combinations thereof.

17. The wet wipe of claim 1 wherein the wet wipe comprises hydrated, rupturable beads in an amount of from about 0.5% (by weight of the fibrous sheet material) to about 50% (by weight of the fibrous sheet material).

18. A substantially dry wipe comprising:
a fibrous sheet material, and
a dehydrated bead comprising an active agent and an encapsulation material that surrounds the active agent, the dehydrated bead being capable of hydrating to become a hydrated, rupturable bead upon contact with an aqueous solution,
wherein the dehydrated bead is embedded within the interior of the fibrous sheet material.

19. The wet wipe of claim 18 wherein the encapsulation material comprises lactose, cellulose, and hydroxypropyl methylcellulose.

20. The wet wipe of claim 18 wherein the encapsulation material comprises mannitol, cellulose, and hydroxypropyl methylcellulose.
